(19) United States
(12) Patent Application Publication
(10) Pub. No.: US 2025/0390969 A1
(43) Pub. Date: Dec. 25, 2025

(54) Virtual Real Estate Assistant (VRA) Enhanced with a Meticulously Fine-Tuned Large Language Model (LLM) and Multi-Source Retrieval-Augmented Generation (RAG) for Unparalleled Home Buying Guidance and Strategic Advantage

(71) Applicant: David Serota, East Amherst, NY (US)

(72) Inventor: David Serota, East Amherst, NY (US)

(21) Appl. No.: 18/752,728

(22) Filed: Jun. 24, 2024

(51) Int. Cl. G06Q 50/16

(52) U.S. Cl. CPC G06Q 50/16

(57) ABSTRACT

An advanced virtual real estate assistant (VRA) system is disclosed, integrating a fine-tuned Large Language Model (LLM) and a Retrieval-Augmented Generation (RAG) module to support homebuyers. The VRA combines structured real estate data (MLS listings, sales records), unstructured property descriptions, legal documents, and buyer preference modeling to provide enhanced property analysis and guidance. The system accesses real-time market data, geospatial information, public records, and community insights to generate personalized recommendations, identify market trends, and suggest negotiation strategies. Key features include hyper-personalized property analysis, intelligent negotiation support, advanced document understanding with risk identification, and proactive, context-sensitive communication. This invention empowers buyers with clear explanations of complex real estate terminology, data-driven negotiation tactics, and timely reminders about contractual contingencies, while emphasizing the importance of seeking professional legal advice at critical transaction stages. The VRA system enhances transparency and efficiency in the home buying process, making it particularly beneficial for first-time buyers.

### BACKGROUND

### Field of the Invention

The present invention pertains to the field of artificial intelligence (AI) applications in real estate technology, specifically focusing on an advanced virtual real estate assistant (VRA). This VRA system integrates a fine-tuned Large Language Model (LLM) with a Retrieval-Augmented Generation (RAG) module to enhance the home buying process. It leverages multiple data sources, including real-time market feeds, geospatial data, public records, and community-sourced information, to deliver comprehensive property analysis, personalized buyer guidance, and proactive communication support. This invention addresses the need for more accessible, data-driven insights and negotiation strategies in real estate transactions, particularly for first-time homebuyers.

### Description of the Related Art

In the intricate landscape of real estate transactions, the process of purchasing a property often presents myriad challenges for buyers. From deciphering complex legal documents to navigating fluctuating market conditions, the journey can be daunting, particularly for first-time homebuyers. Recognizing these challenges, the advent of technology offers a beacon of hope in the form of the Virtual Real Estate Assistant (VRA) system. This cutting-edge solution integrates advanced AI algorithms and multi-layered datasets to provide buyers with comprehensive support, personalized guidance, and data-driven insights throughout their home buying journey.

The significance of the VRA system lies in its ability to revolutionize the traditional real estate buying experience. In an era where access to accurate information and streamlined processes is essential, this innovation stands as a beacon of progress. By empowering buyers with knowledge, tools, and resources previously reserved for seasoned real estate professionals, the VRA system enhances transparency, efficiency, and confidence in the home buying process. Moreover, it addresses key pain points such as information asymmetry, complex paperwork, and uncertain negotiation tactics, ultimately democratizing access to the real estate market and fostering a more informed and empowered buyer community.

Consider the sheer scale of real estate transactions globally, where trillions of dollars exchange hands annually. In the United States alone, residential real estate sales surpassed $1.5 trillion in 2021, underscoring the economic significance of the sector. Despite the substantial financial investments involved, buyers often face challenges such as lack of transparency, difficulty in finding properties that meet their criteria, and navigating complex legal and financial procedures. Moreover, studies indicate that a significant percentage of buyers report feeling overwhelmed and stressed during the home buying process, highlighting the need for innovative solutions like the VRA system to streamline and optimize the experience.

By looking at prior art, multiple advancements have been seen in similar domains. For instance, a U.S. Pat. No. 5,032,989A relates to Real estate search and location system and method. There is provided a method for locating available real estate properties for sale, lease or rental using a database of available properties at a central location and remote stations which use a graphic interface to select desired regions on a map of the areas in interest. The user begins with a region where they are interested in acquiring property and select an inner area within this region by using a pointing device such as a mouse to designate boundaries on a map displayed on screen. This is then zoomed in on and a second area is selected within the zoomed region. The second area is then cross-referenced with the database of available properties whose approximate locations are then pictorially displayed on screen. Information about the properties can then be obtained in textual form.

A U.S. Pat. No. 5,414,621A relates to system and method for computing a comparative value of real estate. The system and method for determining comparative values of comparable properties based on assessment percentages and sales data of the comparable properties to ultimately determine a value for a subject property. In a first embodiment, the “assessment percentage” is the “base property tax” for the subject property and comparable property. A price/tax factor is computed for each comparable property by dividing the sale (or sold) price of the comparable property by its base tax. The price/tax factor for each comparable property is then multiplied by the base tax of the subject property to generate a net comparative value for each comparable property. To take into account appreciation for recently sold comparable properties, an average appreciation is obtained for the area in which the subject and comparable properties are located. The average appreciation is pro-rated to determine the comparative value for each comparable property. On the basis of the comparative values and other pertinent information, the value of the subject property may be set by a real estate agent, bank, appraiser, etc. In second and third embodiments, the “assessment percentage” is the “assessed value” and “phase value”, respectively, which are used to compute the comparative values in a manner similar to the first embodiment.

A U.S. Pat. No. 6,636,803B1 relates to Real-estate information search and retrieval system. A search and retrieval system includes a data terminal which displays icons representing properties in a given real-estate market on a digital map. The icons are selectable so that, when selected, information derived from an MLS or other database are displayed in association with the map. In one embodiment, the data terminal is equipped with a GPS receiver and data-enabled mobile phone. The GPS receiver receives location data which is used by a processor to display an icon representing a current location of the terminal within the map. The data-enabled phone links the terminal to a remote server or database of property information, which may also be displayed when property icons are selected on the map. The property information may include media (e.g., bitmap) data that provide a visual depiction of the property icons selected. By integrating all of these digital sources of information on one terminal, the efficiency and accuracy of the property buying experience is significantly enhanced.

A U.S. Pat. No. 6,876,955B1 relates to Method and apparatus for predicting and reporting a real estate value based on a weighted average of predicted values. The system and method of accurately predicting and reporting a value of a property based on a weighted average of values predicted by at least two prediction models. The system and method include the steps of accessing predicted values, determined by the prediction models, for the property; determining property-specific proportional prediction error distribution information for each predicted value determined by each prediction model; assigning a weight to the predicted value determined by each prediction model by using the property-specific proportional prediction error distribution information; and generating a property-specific weighted average value based on combination of the weight and the predicted value determined by each prediction model and reporting the property-specific weighted average value to minimize prediction error during prediction of the property value.

While various technological advancements have reshaped the real estate landscape in recent years, existing solutions often fall short of addressing the full spectrum of buyer needs. Companies and startups have introduced technologies such as AI-powered property search engines, virtual property tours, and digital transaction management platforms. While these innovations offer improvements in efficiency and convenience, they often lack the depth and sophistication necessary to provide comprehensive support throughout the entire buying process. In contrast, the VRA system represents a paradigm shift in real estate technology, integrating advanced AI capabilities and multi-source data aggregation to offer buyers unparalleled insights, guidance, and assistance from start to finish.

Buyers embarking on the journey of purchasing a home encounter a myriad of challenges and pain points. These may include difficulty in finding properties that match their specific criteria, uncertainty about pricing and negotiation strategies, confusion surrounding legal documentation and procedures, and a lack of timely communication and guidance from real estate professionals. Moreover, navigating the complexities of real estate terminology and contractual language can be daunting for those without extensive industry knowledge or experience, leading to potential misunderstandings and legal complications.

The field of real estate technology has witnessed rapid evolution in recent years, driven by advancements in AI, data analytics, and digital connectivity. However, there remains a crucial gap between the capabilities of existing solutions and the evolving needs of modern homebuyers. The VRA system represents a pioneering effort to bridge this gap by leveraging cutting-edge AI algorithms and multi-source data integration to offer buyers comprehensive support, insights, and assistance at every stage of the buying process. By combining the expertise of legal language models with real-time market data feeds and community-sourced insights, it equips buyers with the tools and knowledge needed to navigate the complexities of real estate transactions with confidence and ease. Ultimately, the VRA system transforms the home buying experience, empowering buyers to make informed decisions and achieve their real estate goals with greater efficiency and peace of mind.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of software that streamlines the real estate buying process by allowing buyers to upload their search parameters and financial qualifications, ensuring they are ready to proceed with property viewings efficiently.

It is also the objective of the invention to facilitate communication between buyers and sellers' agents, automating the scheduling of property viewings and ensuring prompt notifications to both parties, saving time and reducing the risk of missed opportunities.

Another object of this invention is to provide buyers with personalized property suggestions based on their preferences, past search history, and market trends, enhancing their ability to find homes that align with their needs and desires.

It is also an object of the invention to offer buyers comprehensive support during the negotiation process, providing insights into comparable property prices, potential repair costs, and optimal offer strategies based on real-time market data and historical success outcomes.

It is an object of the present invention to utilize a fine-tuned Large Language Model (LLM) designed to process real estate data and buyer preferences, a Retrieval-Augmented Generation (RAG) module for dynamic data retrieval, an AI engine to facilitate negotiation suggestions for possible repair costs.

It is moreover the objective of the invention to simplify the document preparation and signing process for buyers, generating contracts and associated forms automatically and guiding them through the necessary steps with clear instructions, reducing the likelihood of errors or omissions.

It is also the objective of invention to empower buyers with access to a wealth of information and resources, including legal precedents, case summaries, and expert advice from AI algorithms, enabling them to make informed decisions throughout the purchasing journey.

It is another object of the invention to ensure transparency and compliance by reminding buyers of their legal obligations, such as obtaining inspections and securing legal representation, thereby minimizing the risk of legal complications or disputes.

Yet another object of the present invention to enhance buyer satisfaction and confidence by providing proactive guidance and reminders, keeping them informed about important milestones and deadlines in the transaction process, reducing stress and uncertainty.

It is a further aspect of the present invention to promote efficiency and accuracy by integrating real-time market data feeds, geospatial information, public records, and community-sourced insights into the decision-making process, enabling buyers to make well-informed choices.

Thus, it is the objective to facilitate access to transaction documentation, allowing buyers to retrieve and review important records for up to 6 months after the purchase, providing peace of mind and support for future needs or inquiries. Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIGS. 1, FIG. 2, FIG. 3, FIG. 4 illustrates the process flow as per an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The invention relates to a Virtual Real Estate Assistant (VRA) system that integrates advanced technologies to enhance the home buying process for a home buyer without a buyer's agent. The system of the present invention is integrated into one or more devices, requires use of information from one or more computers and may require access to cloud-based computers, systems or internet based information. However, unless stated the configuration or location of information is not meant to limit the basis of the claims. The system leverages a Large Language Model (LLM) and a multi-source Retrieval-Augmented Generation (RAG) module, providing home buyers with comprehensive data analysis, intelligent negotiation strategies, and streamlined transaction management. This VRA is designed to surpass the capabilities of existing real estate platforms by offering hyper-personalized insights, context-sensitive negotiation advice, and proactive communication guidance.

The VRA system as per its preferred embodiments, consists of an LLM meticulously fine-tuned on extensive real estate datasets, including MLS listings, historical sales data, tax records, property descriptions, and legal documents. This fine-tuning enables the LLM to understand intricate real estate terminology and provide clear explanations to users. The RAG module dynamically augments information retrieval by integrating data from real-time market feeds, geospatial data, public records, and community-sourced information, ensuring a holistic analysis of properties.

The system as per its preferred embodiments, allows buyers to upload their search parameters, such as the desired number of bedrooms, specific school districts, garage requirements, and yard preferences. Before initiating the search, buyers must upload a bank pre-qualification letter or proof of funds. If a buyer lacks a financial institution, the system suggests several preferred lenders. Once the pre-qualification document is uploaded, the system begins scrubbing various real estate websites to find matching properties.

As per its preferred embodiments, upon identifying potential properties, the system presents them to the buyer for online review. If the buyer expresses interest in viewing any properties in person, the system generates a text message to the seller or seller's agent, proposing multiple dates and times for showings. Once a showing appointment is confirmed, the system notifies the buyer.

As per its preferred embodiments, after the showing, the system prompts the buyer to decide whether to submit an offer. If the buyer opts to proceed, the system provides a comparable price analysis of similar properties sold within the past 12 months, highlighting high, low, and average sale prices. Additionally, the system includes a question-and-answer feature powered by an AI System offering real-time advice on offer prices, considering factors such as necessary repairs.

As per its preferred embodiments, to submit an offer, the buyer inputs essential details such as the offer price, deposit amount, inspection preference, and attorney information. If the buyer does not have an attorney, the system recommends local participating attorneys and inspectors. The system then generates a contract and all required forms, which the buyer will electronically sign. The completed contract is emailed to the seller/seller's agent, the buyer is CC'd on the email. The email instructs the seller/sellers agent to respond to all with any and all further communication. This step ensures all correspondence and negotiations will not be missed by the buyer or system.

As per its preferred embodiments, if the offer is accepted, the buyer uploads the signed contract to the system, which then sends it to the chosen attorney. The system provides AI-powered assistance to answer questions regarding inspection results and potential repair costs. A built-in calendar tracks important milestones and sends reminders to ensure timely completion of each step in the transaction.

As per its preferred embodiments, the system acts as a virtual transaction coordinator. Tracks the transaction progresses towards closing, the system tracks the pertinent dates for the buyer throughout the buying process. The buyer is notified one week in advance of all benchmarks. Upon notification of scheduled closing, the system contacts the seller via text to arrange the final walkthrough. Upon completion of the purchase, the buyer marks the file as closed in the system. The system retains all documentation for up to 6 months allowing the buyer to access it as needed.

The system leverages multiple data sources, including real-time market feeds, geospatial data, public records, and community-sourced information, to deliver comprehensive property analysis, personalized buyer guidance, and proactive communication support.

In its preferred embodiments, the system includes features for Buyer Search Parameters and Financial Verification. Buyers can input search parameters such as location, property type, number of bedrooms, school district, and other specific preferences. To proceed, buyers are prompted to upload a bank pre-qualification letter or proof of funds. If buyers do not have this documentation readily available, the system offers options for preferred lenders. Once financial verification is obtained, buyers upload the document in PDF format to the system. This step ensures that buyers are financially qualified before the system initiates the property search process, enhancing the efficiency and credibility of the search and subsequent transactions.

The system undertakes a comprehensive search across multiple real estate websites to identify properties that align with the buyer's specified criteria. This search encompasses various parameters, such as location, property type, number of bedrooms, and other preferences set by the buyer. Once the system compiles a list of potential matches, these properties are presented to the buyer for review.

If the buyer shows interest in viewing any of the properties, the system takes on the responsibility of coordinating the showings. This is done by initiating contact with the sellers or their agents through text messages, wherein the system suggests multiple possible dates and times for the showings, allowing for flexibility and convenience. This automated scheduling feature ensures that the buyer's availability is taken into account while proposing viewing appointments.

Upon receiving confirmation from the sellers or their agents regarding the showings, the system promptly notifies the buyer with the confirmed appointment details. This notification includes all pertinent information, such as the date, time, and location of the showing. This detailed coordination helps streamline the process, making it efficient and user-friendly for both buyers and sellers, ultimately enhancing the overall home viewing experience.

Upon contract acceptance, the buyer initiates the next phase of the transaction by checking the accepted offer box and uploading the signed document, signaling the commencement of the contract and transaction management process. This action automatically triggers an email notification to the designated attorney, ensuring that legal oversight is promptly engaged. This step ensures that all parties are aware of the progress and can prepare for the subsequent stages with confidence.

If the buyer opts for an inspection, the system's AI functionality becomes instrumental in facilitating a smooth experience. The AI component assesses the property, providing detailed cost estimates for any necessary repairs and addressing any inquiries the buyer may have. This feature streamlines the inspection process, offering clarity and transparency to both the buyer and seller. By leveraging technology to provide comprehensive information, potential obstacles can be identified and addressed efficiently, minimizing delays and uncertainties.

To maintain momentum and ensure timely progress, the system incorporates a built-in calendar feature/virtual transaction coordinator. This meticulously tracks transaction milestones, from contract acceptance to closing, and sends timely reminders one week before critical dates. By proactively reminding all stakeholders of impending deadlines, the system helps prevent oversights and ensures that necessary actions are taken promptly. This proactive approach enhances efficiency and reduces the risk of delays, contributing to a seamless transaction experience for all parties involved.

The process culminates when the file is cleared for closing, marking the final stages of the transaction. At this juncture, the system orchestrates the scheduling of the final walkthrough, a pivotal step preceding the closing. Additionally, the system promptly notifies the buyer of this crucial appointment, ensuring their presence for the walkthrough. By automating this scheduling aspect, the system minimizes the risk of oversight and ensures that all necessary steps are completed in preparation for the closing. This meticulous attention to detail underscores the system's commitment to facilitating a smooth and efficient transaction process from start to finish. After closing, the buyer can access all transaction documentation for up to 6 months

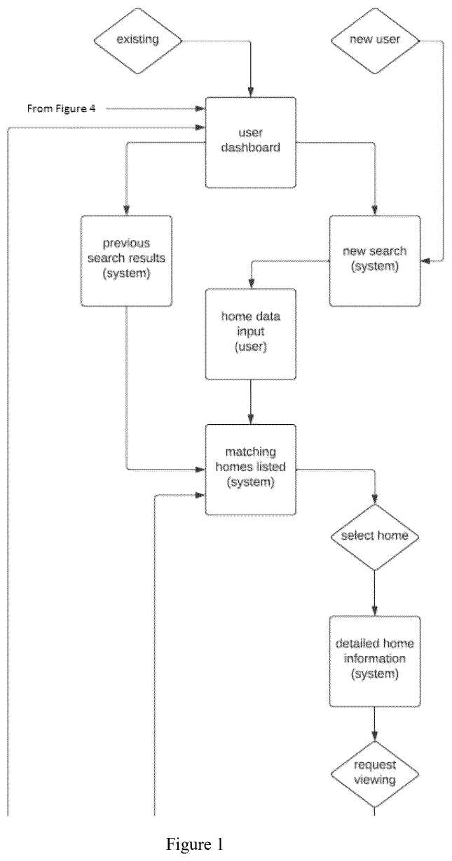

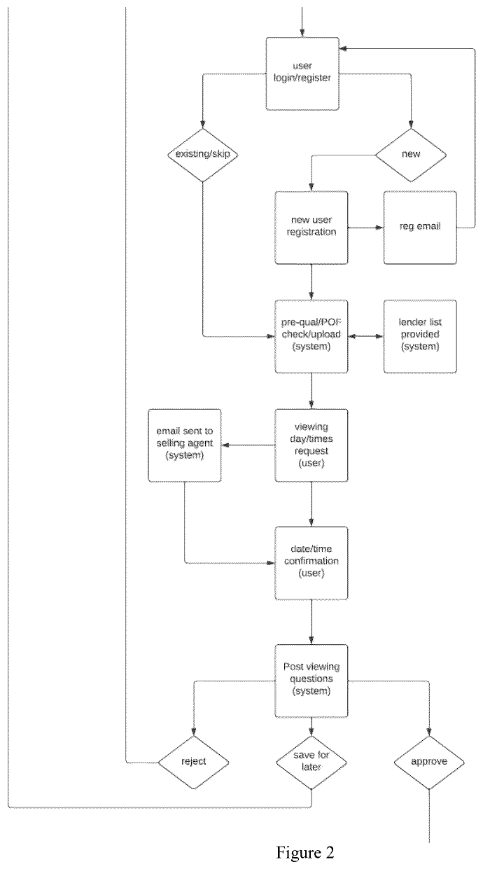

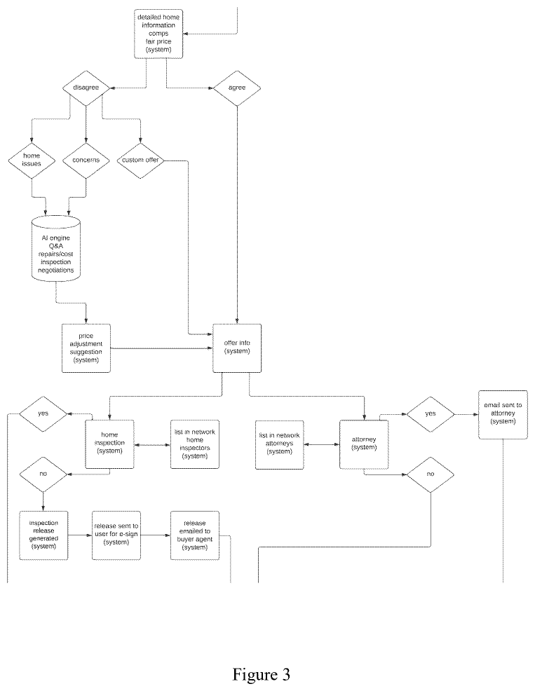

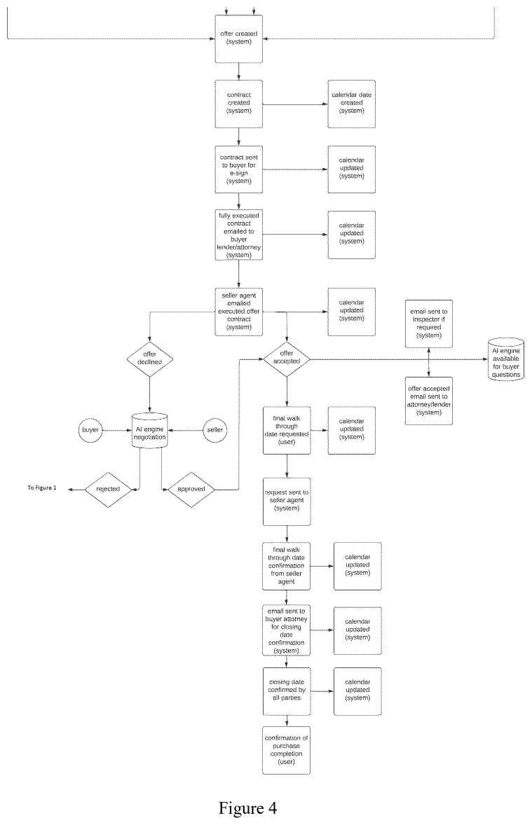

The system can be further understood by looking at FIGS. 1 through 4. Referring to FIG. 1, the present invention discloses a system and method for automating the home buying process through an integrated platform. Initially, the user inputs home preferences or search criteria. The system matches the input with available listings and generates a list of homes (102), providing detailed information for each home. The user selects a home of interest and requests a viewing. Referring to FIG. 2, upon requesting a viewing, the user is prompted to log in or register. Existing users can skip the registration step, whereas new users must complete the registration process. The system checks or requires the user to upload pre-qualification or proof of funds documents. The user then requests specific dates and times for the home viewing, and the system sends a registration email followed by an email to the selling agent with the requested viewing details. The user confirms the date and time for the viewing.

Post-viewing, the user may have questions and decides whether to reject, save for later, or approve the home. Approved homes are managed through the user's dashboard, accessible for both existing and new users. The system provides detailed home information and comparable property prices, suggesting a fair price. The user can either agree or disagree with the suggested price. Disagreements can lead to addressing home issues, raising concerns, or making a custom offer. The AI engine is available for user inquiries. Users can request repairs or cost inspections, and negotiations ensue, potentially leading to price adjustments suggested by the system. The system generates offer information, coordinates home inspections, and if necessary, contacts inspectors and attorneys. Offers are created and contracts generated, which are then sent to the buyer for e-signature and subsequently emailed to the seller's agent.

Upon offer acceptance (130), the system emails the attorney and lender (131) and provides AI assistance for buyer inquiries (132). The calendar is updated with relevant dates (133). If the user requests an inspection (134), (135). The system coordinates with inspector and seller to coordinate dates and times of inspection to gain approval of inspection (136), the system lists network home inspectors (137) and attorneys (138). If negotiations are needed, the AI engine facilitates negotiation suggestions for possible repair costs. An inspection release is generated (139) and sent to the user for e-signature (140), then emailed to the buyer's agent (141). A lender list is provided (142), and previous search results are retrieved, or a new search initiated (143). The fully executed contract is emailed to the buyer, lender, and attorney (144), and calendar dates for benchmarks are created and sent to the buyer one week prior to the event. When the closing is created and updated (145-147). The system sends requests to the seller's agent for final walk-through confirmation (148), and upon confirmation (149), updates the calendar (150). The closing date is confirmed by all parties (151) and the calendar is updated accordingly (152). The user then confirms the completion of the purchase (153).

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A virtual real estate assistant (VRA) system comprising:
a fine-tuned Large Language Model (LLM) designed to process real estate data and buyer preferences;
a Retrieval-Augmented Generation (RAG) module for dynamic data retrieval;
means for buyers to input or upload search parameters and financial verification documents;
means for scrubbing real estate websites to find matching properties;
means for coordinating property viewings and notifying buyers of confirmed appointments;
means for generating offers, including comparable price opinions and repair cost estimates;
means for generating and electronically signing contracts and associated forms;
means for managing the transaction process and providing milestone reminders;
means for post-purchase document access.

2. The VRA system of claim 1, wherein the LLM is fine-tuned on real estate terminology and contractual language to offer clear explanations to buyers.

3. The VRA system of claim 1, wherein the RAG module dynamically augments information retrieval from multiple sources, including real-time market data feeds, geospatial data, public records, and community-sourced information.

4. The VRA system of claim 1, wherein the system provides hyper-personalized property analysis by combining MLS data, buyer preferences, and historical search patterns to generate property insights and market trend assessments.

5. The VRA system of claim 1, wherein the system offers intelligent negotiation support by analyzing buyer's risk tolerance, financial constraints, market conditions, and property specifics, and suggesting negotiation strategies based on recent successful transactions.

6. The VRA system of claim 1, wherein the system performs advanced document understanding by parsing inspection reports, counteroffers, and addendums, summarizing critical findings, translating jargon, and flagging potential red flags.

7. The VRA system of claim 1, wherein the system provides proactive, context-sensitive communication by generating polished correspondence templates, maintaining communication trails, and suggesting context-aware questions and reminders for various transaction stages.

8. The VRA system of claim 1, wherein the system allows buyers to upload or enter search parameters such as property type, location, number of bedrooms, and other preferences.

9. The VRA system of claim 1, wherein the system prompts buyers to upload a bank pre-qualification letter or proof of funds and provides options for preferred lenders if needed.

10. The VRA system of claim 1, wherein the system scrubs multiple real estate websites to find properties matching the buyer's criteria and presents potential matches for review.

11. The VRA system of claim 1, wherein the system coordinates property viewings by contacting sellers/sellers' agents and notifying buyers of confirmed appointments.

12. The VRA system of claim 1, wherein the system provides a comparable price opinion based on recent sales data and highlights potential property issues with estimated repair costs.

13. The VRA system of claim 1, wherein the system allows buyers to input offer details, including price, deposit, inspection requirements, and attorney information, and recommends local professionals if needed.

14. The VRA system of claim 1, wherein the system generates a contract and associated forms, enabling electronic signatures and email notifications to relevant parties.

15. The VRA system of claim 1, wherein the system tracks transaction milestones with a built-in calendar and sends reminders one week before critical dates.

16. The VRA system of claim 1, wherein the system provides AI-driven cost estimates for repairs and answers related questions during the inspection phase.

17. The VRA system of claim 1, wherein the system schedules the final walkthrough and notifies the buyer upon clearance for closing.

18. The VRA system of claim 1, wherein the system enables post-purchase access to transaction documentation for up to seven years.

19. The VRA system of claim 1, wherein the system emphasizes the importance of professional legal advice during critical transaction stages.

20. The VRA system of claim 1, wherein the system ensures buyers are informed and supported throughout the home buying process, promoting transparency and efficiency.
